(19) United States
(12) Patent Application Publication
(10) Pub. No.: US 2005/0143679 A1
(43) Pub. Date: Jun. 30, 2005

(54) Massage glove

(76) Inventors: Mitchell L. Gelber, Prescott, AZ (US); William R. Wise, Chino Valley, AZ (US)

Correspondence Address: GALLAGHER & KENNEDY, P. A., 2575 E. CAMELBACK RD. #1100, PHOENIX, AZ, 85016, US

(21) Appl. No.: 10/748,556

(22) Filed: Dec. 29, 2003

(51) Int. Cl. A61H 1/00; A61H 23/02

(52) U.S. Cl. 601/15; 601/46; 601/72

(57) ABSTRACT

A massage glove having a plurality of vibratory motors secured within it on the palm side. The glove employs small vibrator motors located within the glove fingers. The motors are of a size and weight such that ordinary movement of the therapist's fingers within the glove in traditional massaging movements is not hampered. A heating element may be included in the glove for applying heat in addition to the vibration and the more traditional massage.

### FIELD OF THE INVENTION

A massage glove in accordance with the present invention is provided for the relief of stress-related muscle tension and for other therapeutic massage.

### BACKGROUND

Bulky vibrators that attach to the back of the hand have been known for a long time for vibrating the hand in order to accomplish a vibratory massage. There have also been suggestions in the art of vibrators attached to the backs of the fingers for this purpose. These known units have often employed eccentric-type vibrators whereby a motor drives an off balance armature or rotor. A disadvantage to these is that they are placed on the back of the hand or on the backs of the fingers (rather than the palm side) and vibration must be transmitted through the hand or fingers. The hand and fingers are subject to going numb as a result. In one instance, a glove has been suggested with vibratory elements at the fingertips driven by apparently mechanical connectors running back along the glove to a vibratory element attached at the glove's cuff at the user's wrist.

There is a need for a vibratory massage device attachable to the hand so as to apply vibrations from the device to the massage recipient, but not through the therapist's fingers or hand and without substantially hampering the use of the fingers of the therapist to apply traditional massaging hand pressure and movements.

### BRIEF SUMMARY

In accordance with this invention there is provided a massage glove in which small vibratory elements or motors are affixed within the glove on the palm side thereof rather than the back-of-hand side of the glove. The vibratory motors are sufficiently small and lightweight that they do not interfere with the movement of the user's fingers and hand in traditional massaging force applications and movement.

A glove in accordance with this invention is fashioned of a flexible material forming a glove with interior and exterior and with multiple fingers. The multiple fingers may include the thumb of the glove. A plurality of vibratory motors is affixed to the glove interior within the fingers and on the palm side thereof. A first source of electrical power is provided to energize the vibratory motors via electrical leads running along the glove, preferably in the interior thereof. The vibratory motors have when energized a multidirectional vibratory movement, they vibrate in three dimensions.

In one exemplary preferred embodiment a glove is described that includes a electrically powered heater so that heat as well as vibrations can be applied to the massage recipient. The heater may be supplied electrical power from a dedicated source of electrical power separate from a power source that energizes the vibratory motors.

The vibratory motors used in the glove of the invention preferably have a height less than about 0.15 inches. Between the motors and the flexible material that forms the exterior of the glove padding can be provided so as to avoid harsh engagement between the glove and the massage recipient where the motors are located. Harmful or unpleasant engagement with the massage recipient is thus avoided.

Preferably in gloves according to the invention, at least one and preferably two vibratory motors are affixed within each of the fingers of the glove. The gloves are fashioned in both left and right handed models. Both hands of the therapist can thus be used in the massage.

In one preferred exemplary embodiment a switch or other control for applying electrical power from a power source includes an off position and two on positions. In one of the on positions power is applied via a contact, a switchable conduction path and conductors to apply one level of power to the vibratory motors. Another contact on the switch is coupled with at least one circuit element, preferably a series resistance, that limits the power applied to the vibratory motors. Thus equipped, the glove can be switched to apply stronger or weaker vibrations to the massage recipient. Typically, in one exemplary embodiment the source of power for the vibratory motors is at least one battery and preferably three AAA batteries. These may be carried in a compartment on the glove. Where a heating element is secured within the glove, its power source may be, likewise, at least one battery and preferably three AAA batteries.

### BRIEF DESCRIPTION OF THE DRAWINGS

FIG. 1 is a diagrammatic plan view of a glove in accordance with the present invention and shows a preferred location of vibratory motors 10 on fingers of the glove;

FIG. 2 is a cross-sectional view of a glove like that diagrammatically illustrated in FIG. 1 and illustrates the location of the motors 10 with an outer glove layer and with padding separating the vibratory motors and the outer layer;

FIG. 3 is a schematic diagram of a number of parallel connected motors and a switching power source with high and low energization capability;

FIG. 4 is a schematic illustration of five pairs of vibratory motors for use with a power source like that shown in FIG. 3; and

FIG. 5 is a schematic illustration of a plurality of parallel connected motors and energizing circuit like that of FIG. 3 plus a heater to be located in the glove and a power source for the heater.

### DETAILED DESCRIPTION

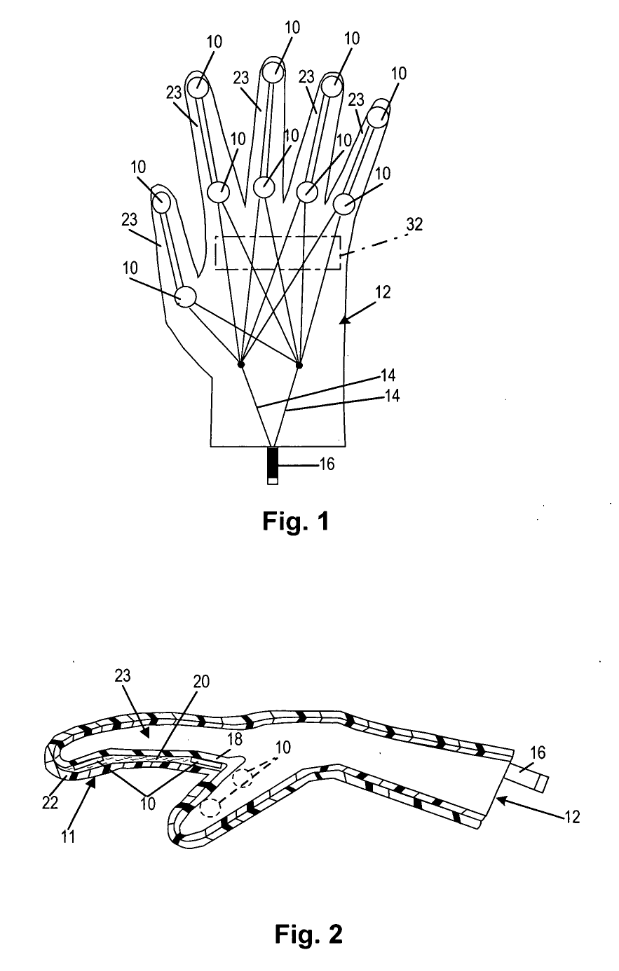

As shown diagrammatically in FIG. 1, relatively small disc-like vibrating motors 10 that attach to the palm side 11 of a glove 12 at selected locations in accordance with this invention permit vibrations from well distributed locations on the hands to be applied during therapeutic massage while causing little or no interference with normal massaging movement of the therapists' hands and fingers. Each vibratory element is an individual vibratory motor from which runs electrical leads 14 to a light-weight battery operated electrical power source 16.

The glove 12 is preferably fashioned of a flexible material of preferably pleasant tactile qualities. As illustrated in FIG. 2, the glove 12 may be a multi-layer glove having an inner liner 18, a light layer of padding 20 isolating the vibratory elements 10 from the patient somewhat, and an outer glove shell 22 of the tactically pleasant thermoplastic or rubber-like preferably hypoallergenic material. In the preferred embodiment illustrated in FIG. 1, two of the vibratory elements 10 are located on each of the fingers 23 of the glove 12 including the thumb. In accordance with one aspect of this invention both left and right-handed gloves are provided so that the practitioner's two hands can be used to massage the patient.

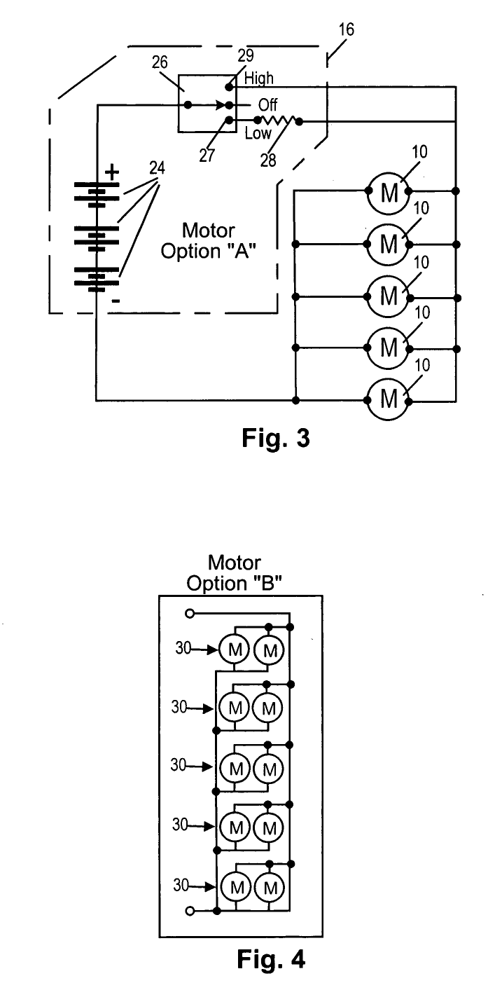

Shown in FIG. 3, three AAA batteries 24 provide the DC power of the supply 16 in one exemplary preferred arrangement. A single pole, double throw (SPDT) switch 26 switches the vibratory motors 10 “on” and “off.” A “low, on” contact 27 of the switch applies electrical power to the motors 10 at a voltage reduced by a drop across a resistor 28. A “high, on” contact 29 applies the full voltage of the three series-connected AAA batteries across five parallel-connected motors 10 for stronger, more intense vibrations from the motors 10. This embodiment contemplates a single motor 10 in each glove finger 23.

Shown in FIG. 4, five pairs 30 of parallel connected motors 10 are connected, again in parallel, to a DC power source such as the three AAA batteries 24 of FIG. 3. Each pair of motors is located in one of the five glove fingers as shown in FIG. 1.

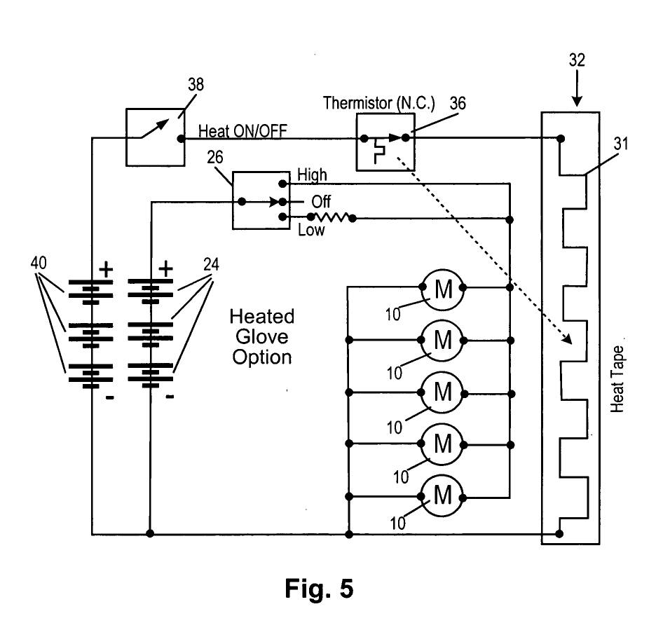

In an alternative embodiment of the invention illustrated in FIG. 5, a glove like that of FIGS. 1 and 2 has, not only the vibratory motors 10 with connected operating circuitry as described above with respect to FIG. 3, but also a heater 32 in the form of a commercially available heat tape. The location of the tape is indicated, as well, in FIG. 1 in phantom outline. The tape is of the kind that has a resistive heating element 34. It may be glued in place, held by VELCRO® or any other suitable connection. Tapes of this kind are commercially available and are used in heated gloves and socks. It protects against overheating by an imbedded thermister 36 and is connected via an on-off switch 38 to a further DC power source such as a further set of three AAA batteries 40. Thus equipped, gloves according to this invention can provide soothing, relaxing heat to sore muscles as well as the therapeutic vibratory massage and the conventional massaging pressure and movement of the therapist's fingers and hands.

The small disc-shaped, commercially available vibratory motors 10 of the present invention are particularly attractive for this application by virtue of their small size and low profile. A further attractive feature is that they vibrate in all directions, up, down and sideways. The disc-like motors 10 are commercially available. The motors are typically used in cell phones and pagers, not in massage devices. Vibratory motors of this kind are available from Sanko Electric, part no. 1E120. They are 0.55 inches in diameter, 0.135 inches thick and operate on 3 volts DC.

The motors 10 can be retained in place on the inner glove liner 18 by any of a number of commercially available glues applied between the motors and the inner liner. In a preferred embodiment the glue sold commercially as SUPER GLUE® successfully retained the motors 10 in place. Other connections such as VELCRO® can be used and can permit relocation of the motors 10 within the glove as desired.

While preferred, exemplary embodiments of the invention have been described, it will be readily apparent to those skilled in the art that modifications and variations may be made without departure from the spirit and scope of the invention as claimed in the appended claims. For example, although a DC power source in the form of three AAA batteries has been shown and described, a common AC to DC converter with low voltage output may provide energization of the motors 10. Also, a rechargeable, battery-operated DC supply such as is used in cell phones and pagers may be employed in therapeutic gloves of the kind envisioned here. Gloves in accordance with the invention can be for self use as well as assisted therapy. The SPDT switch 26 can be of the rotary kind actuated by a thumb wheel or of the toggle type. The DC power source(s) can be mounted on the glove or remotely located and connected by a cord. The power source(s) may be detachable through known separable electrical connectors. The gloves may be typical surgical gloves or other flexible, comfortable material and preferably having pleasing tactile qualities. Although the preferred embodiment described places the vibratory motors 10 in the fingers of the glove, it may be desired in some cases to locate one or more vibratory motors in the palm of the glove, again on the palm side. This may be done in addition to the placement of the motors in the glove fingers or to the exclusion thereof.

1. A massage glove having:
(a) at least one layer of flexible material forming a glove with interior and exterior and multiple fingers;
(b) at least one vibratory motor affixed to the glove interior and on the palm side of the glove;
(c) a first source of electrical power electrically connected with the at least one vibratory motors by electrical leads running along the glove; and
(d) the at least one vibratory motor having, when energized, multidirectional vibratory movement.

2. The massage glove according to claim 1, wherein the at least one vibratory motor has, when energized, three dimensional multidirectional vibratory movement.

3. The massage glove according to claim 1, further comprising:
(e) an electrically powered heater connected for the supply of electrical power by electrical leads running along the glove to an electrical power source.

4. The massage glove according to claim 3, wherein the electrical power source supplying electrical power to the heater is a second source of electrical power.

5. The massage glove according to claim 1, wherein the at least one vibratory motor has a height less than about 0.15 inches.

6. The massage glove according to claim 1, wherein each of the fingers has at least one vibratory motor affixed therein.

7. The massage glove according to claim 6, wherein each of the fingers has a plurality of the vibratory motors affixed therein.

8. The massage glove according to claim 1, further comprising a padding layer intermediate the at least one vibratory motor and the layer of flexible material; whereby, in use, the padding layer protects a massage recipient from harmful or unpleasant engagement.

9. The massage glove according to claim 8, further comprising a flexible layer interior of the flexible material, the padding layer and the at least one vibratory motor, and to which the at least one vibratory motor is affixed.

10. The massage glove according to claim 1, wherein the first source of electrical power comprises at least one battery and a switch for electrically connecting the battery to and disconnecting the battery from the vibratory motors.

11. The massage glove according to claim 10, wherein the switch has a first contact connected via a conductor to the at least one vibratory motor, a second contact connected via at least one power reducing circuit element to the at least one vibratory motor, and a switchable current path connectable to one or the of the contacts and the battery to effect stronger and weaker vibratory motion by the at least one vibratory motors.

12. The massage glove according to claim 11, wherein the switch is a single pole double throw switch.

13. A massage glove comprising:
(a) at least one layer of flexible material forming a glove with interior and exterior, and with multiple fingers;
(b) a plurality of vibratory motors affixed to the glove interior within fingers formed in the glove;
(c) a first source of electrical power electrically connected with the vibratory motors by electrical leads running along the glove; and
(d) an electrically powered heater supplied electrical power by electrical leads running along the glove to an electrical power source.

14. The massage glove according to claim 13, wherein the electrical power source supplying electrical power to the heater is a second source of electrical power.

15. The massage glove according to claim 13, wherein the glove defines a back-of-hand side and a palm side and the vibratory motors are affixed to the glove interior within the fingers and on the palm side of the glove.

16. A massage glove comprising:
(a) at least one layer of flexible material forming a glove with an interior and an exterior, a back-of-hand side and a palm side;
(b) a plurality of electrically operable means for vibrating;
(c) circuit means for supplying electrical power to the means for vibrating; and
(d) the means for vibrating being secured within the glove at the palm side thereof.

17. The massage glove according to claim 16, wherein the means for vibrating are located within the fingers of the glove.

18. The massage glove according to claim 17, wherein plural means for vibrating are located within each of the fingers of the glove.

19. The massage glove according to any one of claims 16-18, further comprising electrically energized means for heating within the glove.
